(19) United States
(12) Patent Application Publication
(10) Pub. No.: US 2024/0181656 A1
(43) Pub. Date: Jun. 6, 2024

(54) ROBOTIC END EFFECTOR

(71) Applicant: Boston Dynamics, Inc., Waltham, MA (US)

(72) Inventors: Haink Tu, Waltham, MA (US); Steven Potter, Waltham, MA (US); Alberto Rodriguez, Cambridge, MA (US)

(21) Appl. No.: 18/073,660

(22) Filed: Dec. 2, 2022

(51) Int. Cl. B25J 15/02; B25J 19/06

(52) U.S. Cl. CPC B25J 15/0213; B25J 19/065

(57) ABSTRACT

An apparatus for a robot includes a set of at least three proximal links. Each proximal link is configured to rotate about a respective joint. Each joint is aligned on a common axis. The apparatus also includes a set of at least three distal links. Each distal link is coupled to a corresponding proximal link and configured to rotate about a second respective joint. Each proximal link comprises an actuator configured to move at least one of the proximal link or the corresponding distal link.

### TECHNICAL FIELD

This disclosure relates generally to robotics and more specifically to systems, methods and apparatuses, including computer programs, for gripping and/or manipulating objects using robotic end effectors.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

A variety of settings today demand high levels of automation, e.g., factories, transportation facilities, material handling facilities and warehouses, among others. One exemplary task that it is desirable to automate is pick-and-place operations (e.g., moving a variety of parts from and/or into containers), but automating this task comes with challenges. For example, some parts are heavy, rigid, and/or complex in terms of exterior geometry, making grasping and/or manipulating difficult. In addition, it is desirable to place some parts in containers with regions having only tight access pathways (e.g., to economize on space in the containers and/or the cost of energy in shipping), imposing spatial constraints on the robotic end effector. It is desirable to have a robotic end effector that overcomes some or all of these challenges, e.g., conform to a wide variety of geometries, secure strong grasps on heavy parts, and/or access tight spaces to pick and/or place a variety of different parts.

The present invention includes systems, methods and apparatuses, including computer programs, for gripping and/or manipulating objects using robotic end effectors. One or more features of the end effector's morphology, kinematics, and/or actuation may help satisfy these goals. In one illustrative embodiment, a robotic end effector comprises a gripper having three fingers, with each finger having two independently actuated phalanges, and all proximal links coaxial at the base of the gripper. Each finger may integrate two complete actuator assemblies including actuators, geared transmissions, and electronics for controlling and powering the two joints inside each finger. However, one having ordinary skill in the art will readily appreciate that a variety of other implementations are possible without departing from the spirit and scope of the invention.

In some embodiments, one or more of these features can enable a large range of grip morphologies (e.g., “jaw,” “palm,” and/or “hook” grasps, as described below) and/or resulting capabilities. In some embodiments, the gripper has a slender form factor that is capable of accessing tight spaces and/or is strong enough to pick up and put down heavy objects (e.g., up to about 40 pounds). For example, in some embodiments, one or more of these features can enable the ability to align all three fingers into a flat “palm” configuration that can access tight spaces. As another example, in some embodiments, the proximal actuators can be used jointly as a slender “wrist,” e.g., to reorient the gripper along their common axis without changing the shape of the gripper.

In some embodiments, an end effector (e.g., a gripper) having the ability to generate strong, secure holds on a large variety of objects can enable robot manipulation capabilities in diverse areas, including but not limited to: (i) agile handling of objects from a wide range of initial poses to a wide range of end poses; (ii) forceful manipulation of the environment with a held object (e.g., when operating a mechanism such as a door, latch, drawer, or valve) and/or when using a tool or manipulating a heavy object against the environment; and/or (iii) agile dynamic transport of a heavy object. In some embodiments, housing the actuation components in the proximal links allows modularity of design and fabrication and/or rapid iteration of further end effector morphologies (e.g., using additional links).

In one aspect, the invention features an apparatus for a robot. The apparatus includes a set of at least three proximal links, each proximal link configured to rotate about a respective joint, each joint aligned on a common axis, and a set of at least three distal links, each distal link coupled to a corresponding proximal link and configured to rotate about a second respective joint. Each proximal link comprises an actuator configured to move at least one of the proximal link or the corresponding distal link.

In some embodiments, each proximal link is configured to rotate independently of each other proximal link.

In some embodiments, each distal link is configured to rotate independently of each other distal link and each proximal link.

In some embodiments, each proximal link comprises a second actuator to move the other of the proximal link or the corresponding distal link.

In some embodiments, each proximal link comprises a geared transmission.

In some embodiments, each proximal link comprises electronic circuitry for at least one of controlling, powering or communicating with that proximal link.

In some embodiments, each proximal link comprises electronic circuitry for at least one of controlling, powering or communicating with its corresponding distal link.

In some embodiments, the apparatus is configured to be capable of performing at least one palm grasp, at least one hook grasp, and at least one jaw grasp.

In some embodiments, each proximal link and each corresponding distal link form a modular finger member.

In some embodiments, the set of proximal links comprises at least four proximal links and the set of distal links comprises at least four corresponding distal links.

In some embodiments, the set of proximal links comprises at least five proximal links and the set of distal links comprises at least five corresponding distal links.

In some embodiments, each actuator comprises an electric motor having a clutched rotor. In some embodiments, each electric motor is mechanically coupled to a stepped spur gear, the electric motor having a rotary axis that is different from an axis of rotation of the corresponding proximal link. In some embodiments, each stepped spur gear is mechanically coupled to a corresponding planetary gearbox.

In some embodiments, each proximal link is configured to withstand a peak torque of over 30 Nm. In some embodiments, each proximal link is configured to operate at a peak speed of over 800 degrees per second.

In some embodiments, each proximal link is coupled to a common rigid member. In some embodiments, the common rigid member is rotatable along an axis that is perpendicular to the common axis. In some embodiments, the common rigid member is configured to attach to a limb of the robot.

In some embodiments, each proximal link has a linear dimension that is longer than a linear dimension of each corresponding distal link.

In some embodiments, the robot is a humanoid robot. In some embodiments, the robot is a mobile robot with a manipulator.

In some embodiments, any two of the at least three proximal links are capable of rotation to an angular separation of at least 180 degrees. In some embodiments, any two of the at least three distal links are capable of rotation to an angular separation of at least 180 degrees when the two corresponding proximal links are aligned.

In some embodiments, at least one of the proximal links comprises a breakaway feature. In some embodiments, the breakaway feature comprises a deformable member configured to break when more than a first threshold force is applied along a first breakaway axis. In some embodiments, the deformable member is further configured to break when more than a second threshold force is applied along a second breakaway axis, the first threshold force being different from the second threshold force, and the first breakaway axis being different from the second breakaway axis.

In some embodiments, at least one of the proximal links comprises a slip clutch configured to slip when a threshold is met.

In some embodiments, the apparatus further includes a set of at least three additional links, each additional link coupled to a corresponding distal link and configured to rotate independently about a third respective joint.

In some embodiments, at least one distal link comprises an exterior geometry that differs from at least one other distal link. In some embodiments, at least one distal link comprises a flat surface exterior, at least one distal link comprises a first tapered surface having a first pitch, and at least one distal link comprises a second tapered surface having a second pitch, the second pitch tapered away from the first pitch. In some embodiments, the apparatus is a robotic end effector.

In one aspect, the invention features a method. The method comprises rotating, by a first actuator assembly in a first proximal link of a robotic end effector, the first proximal link about a first joint by a first angle, rotating, by a second actuator assembly in a second proximal link of the robotic end effector, the second proximal link about a second joint by a second angle, rotating, by a third actuator assembly in a third proximal link of the robotic end effector, the third proximal link about a third joint by a third angle, and rotating, by a fourth actuator assembly in the first proximal link of the robotic end effector, a first distal link coupled to the first proximal link at a fourth joint by a fourth angle. The first joint, the second joint and the third joint are aligned along a common rotational axis.

In some embodiments, the first proximal link is configured to rotate independently of the second proximal link and the third proximal link.

In some embodiments, the first distal link is configured to rotate independently of the first, second and third proximal links.

In some embodiments, each of the first, second and third actuator comprises a geared transmission. In some embodiments, each of the first, second and third actuator comprises an electric motor having a clutched rotor.

In some embodiments, the method further comprises rotating a common rigid member coupled to each of the first, second and third proximal links, wherein the common rigid member is rotatable along an axis that is perpendicular to the common rotational axis.

In some embodiments, the method further comprises breaking a deformable member included in the first proximal link when more than a first threshold force is applied along a first breakaway axis. In some embodiments, the method further comprises breaking the deformable member when more than a second threshold force is applied along a second breakaway axis, the first threshold force being different from the second threshold force, and the first breakaway axis being different from the second breakaway axis.

In one aspect, the invention features an actuator assembly for a robot. The actuator assembly includes an electric motor having a rotor configured to rotate about a rotary axis, a first spur gear mechanically coupled to the rotor and configured to rotate about a first intermediate axis different from the rotary axis, and a planetary gear mechanically coupled to the first spur gear, the planetary gear defining an axis of rotation of a robotic joint, wherein the axis of rotation of the robotic joint is displaced from the rotary axis of the rotor of the electric motor.

In some embodiments, the actuator assembly further comprises a second spur gear mechanically coupled to the first spur gear and configured to rotate about a second intermediate axis different from the first intermediate axis.

In some embodiments, the actuator assembly further comprises a second electric motor having a second rotor configured to rotate about a second rotary axis, a second spur gear mechanically coupled to the second rotor and configured to rotate about a first intermediate axis different from the second rotary axis, and a second planetary gear mechanically coupled to the second spur gear, the second planetary gear defining a second axis of rotation of a second robotic joint, wherein the second axis of rotation of the robotic joint is displaced from the second rotary axis of the second rotor of the second electric motor.

In some embodiments, the actuator assembly further comprises a third spur gear mechanically coupled to the second spur gear and configured to rotate about a second intermediate axis different from the first intermediate axis.

In one aspect, the invention features a method. The method comprises receiving, by a computing device of a robot having an end effector with at least three proximal links, an indication of an object to be grasped by the end effector, determining, by the computing device, based on the indication, a physical configuration for the end effector, instructing, by the computing device, the end effector to assume the physical configuration, and instructing, by the computing device, the end effector to approach the object in the physical configuration. The physical configuration is selected from a group of configurations including a first configuration and a second configuration.

In some embodiments, in the first configuration, each proximal link is rotated by a first respective angle with respect to a respective base member to which the proximal link is coupled, and in the second configuration, each proximal link is rotated by a second respective angle with respect to the respective base member to which the proximal link is coupled. The at least one first respective angle is different from the at least one second respective angle.

In some embodiments, the method further comprises instructing, by the computing device, the end effector to grip the object while in the physical configuration.

In some embodiments, the method further comprises instructing, by the computing device, the end effector to move one or more links of the end effector to adjust a grip on the object.

In some embodiments, the method further comprises instructing, by the computing device, the end effector to move one or more links of the end effector to reposition the object.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1A illustrates an example configuration of a robotic device, according to an illustrative embodiment of the invention.

FIG. 1B illustrates an example configuration of a robotic device coupled to a robotic end effector, according to an illustrative embodiment of the invention.

FIG. 2A illustrates an example of a humanoid robot, according to an illustrative embodiment of the invention.

FIG. 2B illustrates an example of a humanoid robot having two robotic end effectors, according to an illustrative embodiment of the invention.

FIG. 3A is a schematic illustration of an example robotic end effector having three proximal links aligned on a common axis and three corresponding distal links, according to an illustrative embodiment of the invention.

FIG. 3B is a schematic illustration of the example robotic end effector of FIG. 3A with the proximal links and the corresponding distal links in different positions, according to an illustrative embodiment of the invention.

FIG. 3C is a schematic illustration of an example robotic link for a robotic end effector, according to an illustrative embodiment of the invention.

FIG. 3D is a schematic illustration of a robotic end effector in which one proximal link is rotated more than 180 degrees with respect to another proximal link, according to an illustrative embodiment of the invention.

FIGS. 4A-4K illustrate different grasp positions for an example robotic end effector, according to an illustrative embodiment of the invention.

FIG. 5 is a photograph of an example robotic end effector, according to an illustrative embodiment of the invention.

FIG. 6 is a flowchart of an exemplary computer-implemented method, according to an illustrative embodiment of the invention.

FIG. 7 is a flowchart of another exemplary computer-implemented method, according to an illustrative embodiment of the invention.

### DETAILED DESCRIPTION

An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device). For instance, the control system may determine locations at which to place the robotic device's feet and/or the force to exert by the robotic device's feet on a surface based on the aggregate orientation.

In some implementations, the robotic device may include force sensors that measure or estimate the external forces (e.g., the force applied by a leg of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

The control system may be configured to actuate one or more actuators connected across components of a robotic leg. The actuators may be controlled to raise or lower the robotic leg. In some cases, a robotic leg may include actuators to control the robotic leg's motion in three dimensions. Depending on the particular implementation, the control system may be configured to use the aggregate orientation, along with other sensor measurements, as a basis to control the robot in a certain manner (e.g., stationary balancing, walking, running, galloping, etc.).

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

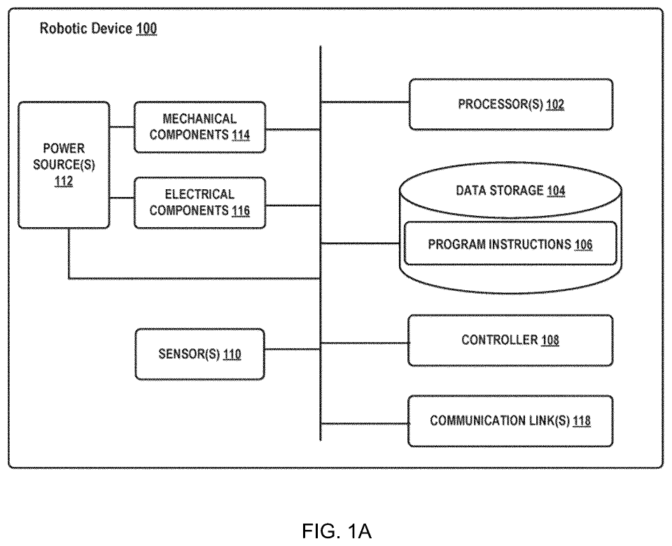

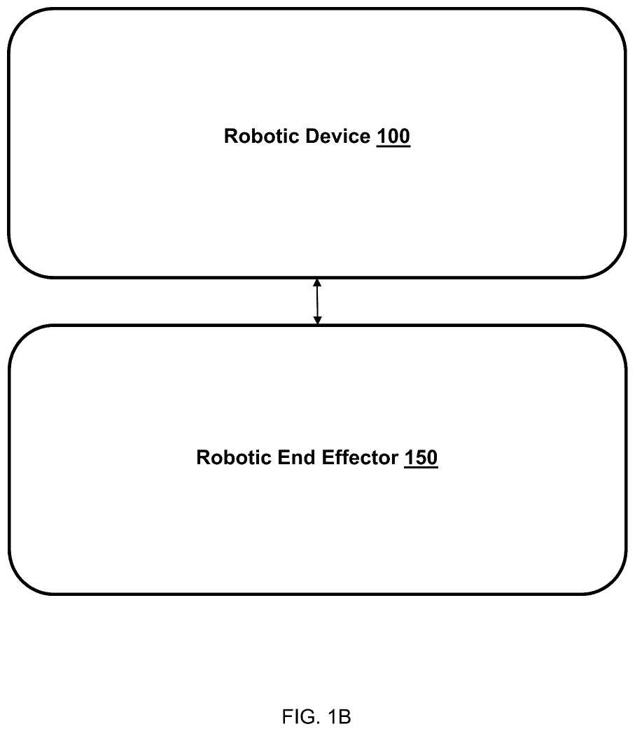

Referring now to the figures, FIG. 1A illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1A, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic system 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic system 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic system 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic system 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic system 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 118, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

FIG. 1B illustrates an example configuration of a robotic device 100 (e.g., as shown in FIG. 1A above) coupled to a robotic end effector 150, according to an illustrative embodiment of the invention. The robotic end effector 150 may be coupled to the robotic device 100 mechanically (e.g., may be physically mounted), electrically (e.g., may be wired), and/or communicatively (e.g., may communicate electronically with the robotic device 100). In some embodiments, the robotic end effector 150 can receive power from the robotic device 100 and/or control instructions from the robotic device 100 and/or an operator of the robotic device 100. In some embodiments, the robotic end effector 150 comprises electronic circuitry for control, power, and/or communications for the robotic end effector 150. In some embodiments, the robotic end effector 150 is detachable from the robotic device 100.

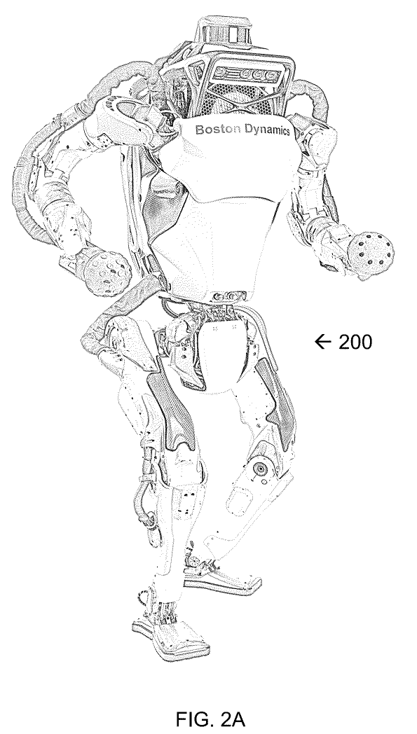

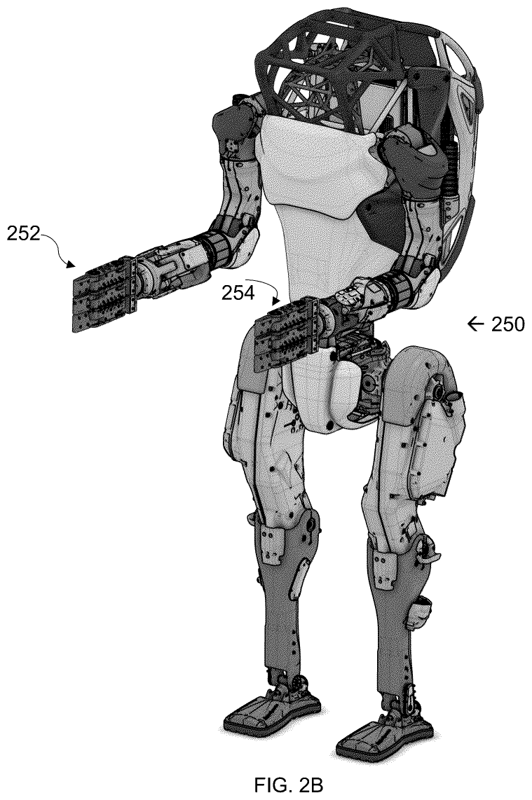

FIG. 2A illustrates an example of a humanoid robot, according to an illustrative embodiment of the invention. The robotic device 200 may correspond to the robotic device 100 shown in FIG. 1A. The robotic device 200 serves as a possible implementation of a robotic device that may be configured to include the systems and/or carry out the methods described herein. Other example implementations of robotic devices may exist.

The robotic device 200 may include a number of articulated appendages, such as robotic legs and/or robotic arms. Each articulated appendage may include a number of members connected by joints that allow the articulated appendage to move through certain degrees of freedom. Each member of an articulated appendage may have properties describing aspects of the member, such as its weight, weight distribution, length, and/or shape, among other properties. Similarly, each joint connecting the members of an articulated appendage may have known properties, such as the degrees of its range of motion the joint allows, the size of the joint, and the distance between members connected by the joint, among other properties. A given joint may be a joint allowing one degree of freedom (e.g., a knuckle joint or a hinge joint), a joint allowing two degrees of freedom (e.g., a cylindrical joint), a joint allowing three degrees of freedom (e.g., a ball and socket joint), or a joint allowing four or more degrees of freedom. A degree of freedom may refer to the ability of a member connected to a joint to move about a particular translational or rotational axis.

The robotic device 200 may also include sensors to measure the angles of the joints of its articulated appendages. In addition, the articulated appendages may include a number of actuators that can be controlled to extend and retract members of the articulated appendages. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

The robotic device 200 may be configured to send sensor data from the articulated appendages to a device coupled to the robotic device 200 such as a processing system, a computing system, or a control system. The robotic device 200 may include a memory, either included in a device on the robotic device 200 or as a standalone component, on which sensor data is stored. In some implementations, the sensor data is retained in the memory for a certain amount of time. In some cases, the stored sensor data may be processed or otherwise transformed for use by a control system on the robotic device 200. In some cases, the robotic device 200 may also transmit the sensor data over a wired or wireless connection (or other electronic communication means) to an external device.

FIG. 2B illustrates an example of a humanoid robot 250 having two robotic end effectors 252, 254, according to an illustrative embodiment of the invention. In FIG. 2B, the robotic end effectors 252, 254 are connected to the humanoid robot 250 (e.g., mechanically, electrically, and/or communicatively) and function as the “hands” of the humanoid form shown. Each robotic end effector 252, 254 can function as described in greater detail below.

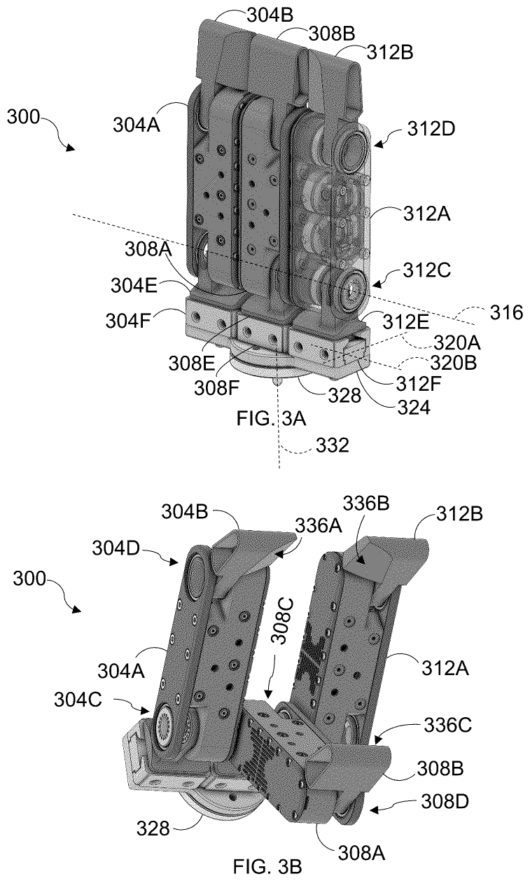

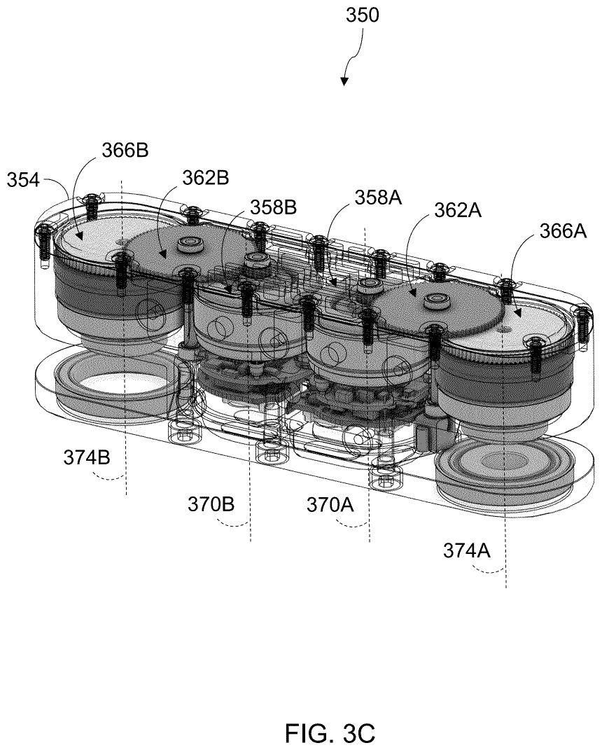

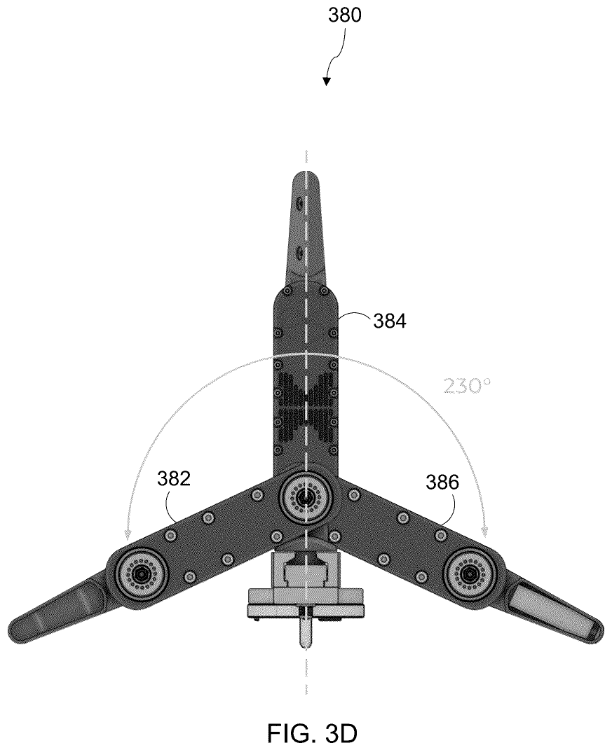

FIG. 3A is a schematic illustration of an example robotic end effector 300 having three proximal links 304A, 308A, 312A aligned on a common axis 316 and three corresponding distal links 304B, 308B, 312B (each coupled to a corresponding proximal link), according to an illustrative embodiment of the invention. FIG. 3B is a schematic illustration of the example robotic end effector 300 of FIG. 3A with the proximal links 304A, 308A, 312A and the corresponding distal links 304B, 308B, 312B in different positions, according to an illustrative embodiment of the invention. Although three proximal links are shown, a different number of proximal links (and/or corresponding distal links) could be used, such as four or five (or more), without departing from the spirit or scope of the invention. In some embodiments, one end effector having multiple (e.g., two) proximal links aligned at a first common rotation axis can be used in conjunction with another end effector having multiple (e.g., another two) proximal links aligned at a second common rotation axis (e.g., forming two two-finger claws capable of holding and/or moving a long rigid pipe).

In FIGS. 3A-3B, each of the proximal links 304A, 308A, 312A is configured to rotate about a respective joint 304C, 308C, 312C. Each of the distal links 304B, 308B, 312B is coupled to a corresponding proximal link 304A, 308A, 312A and is configured to rotate about a second respective joint 304D, 308D, 312D. Some or all of these rotations can be supported by actuators included within the corresponding proximal links 304A, 308A, 312A (e.g., as shown and described below in FIG. 3C). In some embodiments, each proximal link 304A, 308A, 312A can include one actuator for rotating the proximal link about the common axis 316 and another actuator for rotating the corresponding distal link 304B, 308B, 312B relative to the corresponding proximal link 304A, 308A, 312A. In some embodiments, such as the embodiment shown in FIGS. 3A and 3B, each proximal link and its corresponding distal link (e.g., proximal link 304A and distal link 304B) form a modular “finger”, which can move and/or be replaced independently of the other fingers. In some embodiments, such as the one shown in FIGS. 3A-3B, each proximal link is longer than its corresponding distal link, although different configurations are possible. Additionally, in some embodiments, one or more additional links can be coupled to each proximal link (e.g., as intermediate links, coupled directly and/or indirectly) before reaching the final and/or distal link (e.g., “chained” using the same basic actuator assembly to build a variety of additional end effector morphologies).

In FIGS. 3A and 3B, each of the proximal links 304A, 308A, 312A is coupled (e.g., mechanically, electrically and/or communicatively) to a respective base member 304E, 308E, 312E. The base members 304E, 308E, 312E can remain stationary as their respective proximal links 304A, 308A, 312A rotate about joints 304C, 308C, 312C. The base members 304E, 308E, 312E can be further fixed to one or more detachable (e.g., breakable and/or deformable) members 304F, 308F, 312F, which can include a breakaway feature designed to break off of and/or detach from (e.g., snap off of) a mount member 324 when more than a threshold load (e.g., force and/or torque) is applied. In some embodiments, the detachable members 304F, 308F, 312F are made of a breakable material such as a 3D printed plastic, a fiber-reinforced plastic, an acrylic, or a cast or sintered aluminum alloy. In some embodiments, the detachable members 304F, 308F, 312F utilize breakable fastening members (e.g., screws). In some embodiments, the breakable material retains a high degree of stiffness up to a threshold load, but breaks abruptly after the threshold is exceeded. In some embodiments, the detachable members 304F, 308F, 312F click or snap out of place when more than a threshold force is applied (e.g., deform or deflect enough to release a mating feature in the corresponding base members 304E, 308E, 312E). In some embodiments, suitable retention features include a convex surface on the detachable members 304F, 308F, 312F engaging a concave surface on base members 304E, 308E, 312E (or vice versa). In some embodiments, one or both mating parts are made of a strong, resilient plastic (e.g., nylon or acetal). In some embodiments, the magnitude of the threshold varies depending upon the direction of its application. Taking member 312F as an example, exceeding a first threshold may cause the detachable member 312F to break or snap off the mount member 324 if a load is applied to the member 312F along the direction of a first axis 320A (or a parallel axis), whereas exceeding a second threshold may cause the detachable member 312 to snap or break off the mount member 324 if a load is applied to the member 312F along the direction of a second axis 320B.

The mount member 324 can be coupled (e.g., mechanically, electrically, translationally and/or rotationally) to a common base member 328. In some embodiments, the mount member 324 can rotate about the common base member 328. In FIG. 3A, the mount member 324 rotates about the common base member 328 with respect to rotation axis 332. In some embodiments, the common base member 328 can couple to a robotic device (e.g., as shown and described above in FIG. 2B). In addition, in FIG. 3A the proximal links 304A, 308A, 312A are each aligned (e.g., rotated zero degrees with respect to each other), but in FIG. 3B the proximal link 308A is rotated at an angle with respect to the proximal links 304A, 312A. In addition, each of the proximal links 304A, 308A, 312A are rotated with respect to the mount member 324, with proximal links 304A, 312A rotated “upward” as shown and proximal link 308A rotated “downward” as shown. In some embodiments, the proximal links 304A, 308A, 312A can rotate 180 degrees or more with respect to each other (e.g., 190, 200, 210, 220, 230 or 240 degrees). For example, FIG. 3D shows a robotic end effector 380 having three proximal links 382, 384, 386, in which one proximal link 382 is rotated 230 degrees with respect to another proximal link 386. In some embodiments, each of the distal links 304B, 308B, 312B has a similar rotation range relative to the respective proximal links.

In some embodiments, each of the distal links 304B, 308B, 312B can have at least one differing exterior surface. For example, in FIGS. 3A and 3B, the distal link 304B has an exterior surface 336A that is tapered in one direction (e.g., upward and to the right, as shown) and the distal link 312B has an exterior surface 336B that is tapered in another direction (e.g., upward and to the left, as shown), while the distal link 308B has an exterior surface 336C that does not include a similar kind of taper. In some embodiments (e.g., as shown in FIGS. 3A-3B), a certain set of taper features exists on one side of the distal links 304B, 308B, 312B but not the other, and therefore is relevant in some grip postures (e.g., FIG. 3B) but not others (e.g., if the rotations shown in FIG. 3B were flipped and/or inverted, the gripping surfaces would all be flat, with the tapers not interacting with the gripped object, but instead facing outward). In some embodiments, this range of available gripping surfaces can enable a greater range of gripping capabilities and/or conformity to a greater variety of manipulated objects (e.g., ones whose varying exterior geometries may interact with one grip orientation better than another). For example, tapers on exterior surfaces 336A, 336B may help the robotic end effector 300 grip a round object, whereas flat surfaces may help the robotic end effector 300 grip a prismatic object.

In FIG. 3A, the proximal link 312A is shown rendered with a translucent casing to permit viewing of certain interior components. Additional details of such components are illustrated and described further in FIG. 3C. FIG. 3C is a schematic illustration of an example robotic link 350 for a robotic end effector (e.g., the robotic end effector shown in FIGS. 3A-3B), according to an illustrative embodiment of the invention. Each of the proximal links 304A, 308A, 312A from FIGS. 3A-3B can comprise one robotic link 350. The robotic link 350 includes a housing 354 (depicted as a line outline to permit viewing of interior components) that provides a structure to and/or an exterior casing for the robotic link 350. The housing 354 can enclose two independent actuator assemblies (e.g., one to move a proximal link and one to independently move a corresponding distal link or intermediate link), each of which can have similar components. Including actuators in the housing (i.e., within the “finger” components or phalanges themselves) can enable the “palm” of the gripper to be more compact than prior designs, creating a slender profile that allows the robotic end effector to reach into tight spaces. In some embodiments, the housing 354 comprises Aluminum or another material that conducts and/or carries heat away from the internal components.

The components of one of the actuator assemblies in the robotic link 350 are described below with numerical elements having “A” suffixes, and similar components for the other actuator assembly are also visible in FIG. 3C with similar numerals having “B” suffixes. The electric motors 358A, 358B (i.e., one for each actuator assembly) can be included in the housing 354. Each electric motor 358A, 358B can include a clutched rotor. In some embodiments, the clutched rotor can be configured to slip when a predetermined threshold is satisfied, thereby providing a layer of protection (e.g., from overload events) to the mechanically linked gear train. The electric motors 358A, 358B can each be mechanically coupled (e.g., via the clutched rotor) to an intermediate member 362A, 362B (e.g., a stepped spur gear) configured to rotate about an axis different than the rotary axis 370A, 370B of its corresponding motor to which it is mechanically coupled. The intermediate members 362A, 362B can each be mechanically coupled to a respective output member 366A, 366B (e.g., a planetary gearbox). The respective output member 366A, 366B can drive rotation of the respective link about the respective joint, as described above. It should be appreciated that although only a single intermediate member 362A, 362B is shown as being mechanically coupled between a respective electric motor 358A, 358B and a respective output member 366A, 366B, in some embodiments, multiple intermediate members (e.g., a large spur gear and a small spur gear) may be mechanically coupled between a respective electric motor and a respective output member. For instance, when the intermediate member 362A is replaced with two intermediate members configured to rotate on different axes, the result is a four-stage gearbox that includes the two intermediate members, the electric motor 358A and the output member 366A. Note that although certain mechanical couplings described above include direct contact between the respective parts, indirect contact and/or other forms of rigid contact (with or without intervening parts) can also be used in some embodiments.

As shown, the electric motors 358A, 358B have rotary axes 370A, 370B that are different from the rotary axes 374A, 374B of the corresponding links. Such an arrangement can enable compactness of design and inclusion of all actuator assembly components (and also electronic circuitry for controlling and/or powering each actuator assembly) in a slender form factor. The robotic link 350 can also be modular, such that a number of links (e.g., two, three or four) can be “chained” together, either to provide a base link for a number of fingers, or to extend a single finger to higher numbers of phalanges that can be actuated independently. In some embodiments, each actuator assembly can have a joint strength of over 30 Nm at peak, which can be five times the joint strength of comparable existing grippers. In some embodiments, each actuator assembly can have a joint speed of over 800 degrees per second at peak, which can be about ten times the joint speed of comparable existing grippers.

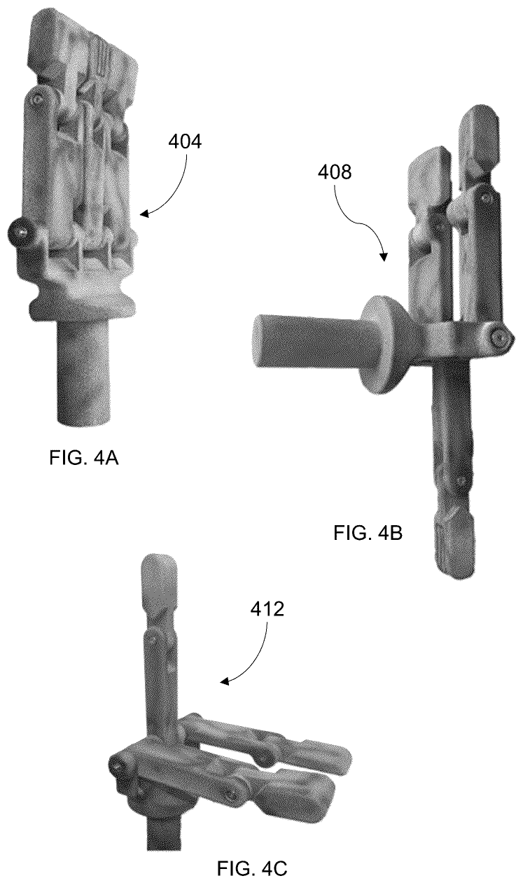

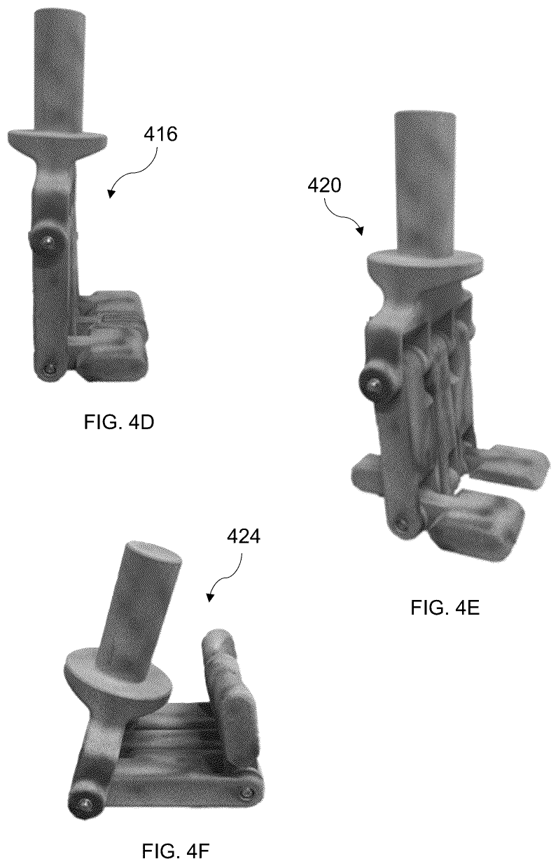

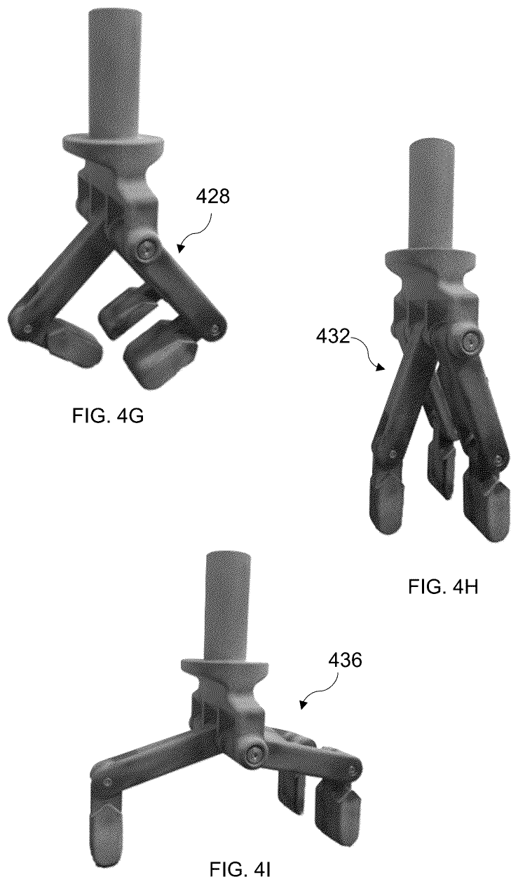

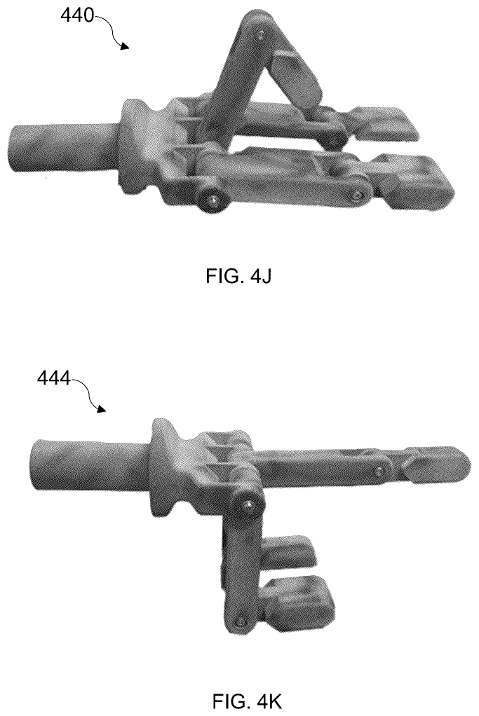

FIGS. 4A-4K illustrate different grasp positions 404, 408, 412, 416, 420, 424, 428, 432, 436, 440, 444 for an example robotic end effector, according to an illustrative embodiment of the invention. FIGS. 4A-4K illustrate the large variety of grasp geometries enabled by some embodiments described herein, which may allow for securing strong grasps (e.g., on heavy parts) and/or accessing tight spaces (e.g., in pick-and-place operations). FIGS. 4A-4C illustrate various “palm grasps,” in which the proximal links are angled in different directions with respect to a base of the robotic end effector (e.g., corresponding to a limb of the robot to which the robotic end effector is attached), but the distal links are not angled (at all or only trivially) with respect to the corresponding proximal links. For example, FIG. 4A illustrates an “open palm” grasp 404, in which all three proximal links and all three distal links are rotationally aligned. FIG. 4B illustrates a “wide palm” grasp 408, in which the first and third proximal links are angled 90 degrees with respect to the base (with the corresponding distal links in line), and the second proximal link is angled 90 degrees in the other direction with respect to the base (with the corresponding distal link in line). In this grasp, the first and third “fingers” are oriented 180 degrees from the second finger. FIG. 4C illustrates a “corner palm” grasp 412, in which the first and third proximal links are angled 90 degrees with respect to the base (with the corresponding distal links in line), and the second proximal link is parallel to the base (with the corresponding distal link in line).

FIGS. 4D-4F illustrate various “hook grasps” in which the proximal links are now angled with respect to the distal links (instead of falling in line with them). FIG. 4D illustrates an “L-hook” grasp 416, in which each proximal link is parallel (or approximately parallel) to the base and each distal link is at a right angle to its corresponding proximal link. FIG. 4E illustrates a “T-hook” grasp 420, in which the first and third distal links are angled 90 degrees one way from their corresponding proximal links, while the second distal link is angled 90 degrees the other way from its corresponding proximal link (such that the first and third distal links are angled 180 degrees from the second distal link). FIG. 4F illustrates a “U-hook” grasp 424, in which all three proximal links are angled the same amount from the base, and all three distal links are angled further still (here by the same amount) from the proximal links. FIGS. 4G-4K illustrate various “jaw grasps”, namely, a “pinch jaw” grasp 428 in FIG. 4G; a “narrow jaw” grasp 432 in FIG. 4H; a “wide jaw” grasp 436 in FIG. 4I; a first jaw variation grasp 440 in FIG. 4J; and a second jaw variation grasp 444 in FIG. 4K, each of which may be particularly suitable to a particular application, given a specified set of grasped object parameters and/or spatial constraints.

In some embodiments, one or more of the grasps illustrated can be maintained while both gripping an object and rotating the grasp with respect to the base of the gripper. Such a capability can simplify the wrist of the robot by removing the need for a “wrist bend” actuator, which can in turn make the robot arm lighter, more compact, more robust to impacts, and/or lower cost. In some embodiments, when all proximal links are aligned (thus making the distal joint axes coaxial), the proximal links can function as a palm, and the distal links can function as smaller “footprint” versions of the palm grasps shown in FIGS. 4A-4C. For example, the T-Hook in FIG. 4E may be considered a miniature version of the palm grasp shown in FIG. 4B. In some embodiments, this capability can be used to enable different orientations and/or approach angles by orienting the “palm” comprised of the proximal links.

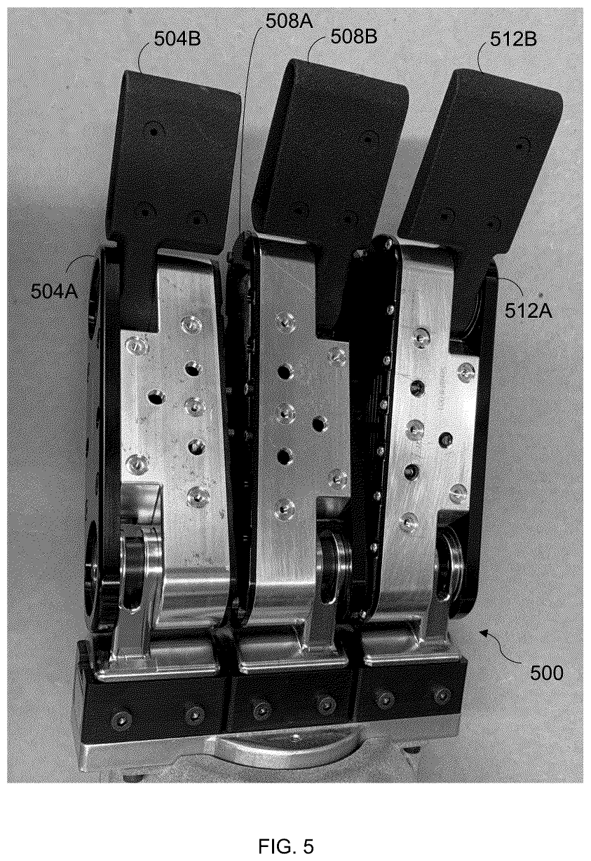

FIG. 5 is a photograph of an example robotic end effector 500, according to an illustrative embodiment of the invention. The robotic end effector 500 includes similar components to those shown and described above in FIGS. 3A-3B, including three proximal links 504A, 508A, 512A and three corresponding distal links 504B, 508B, 512B (each coupled to a corresponding proximal link).

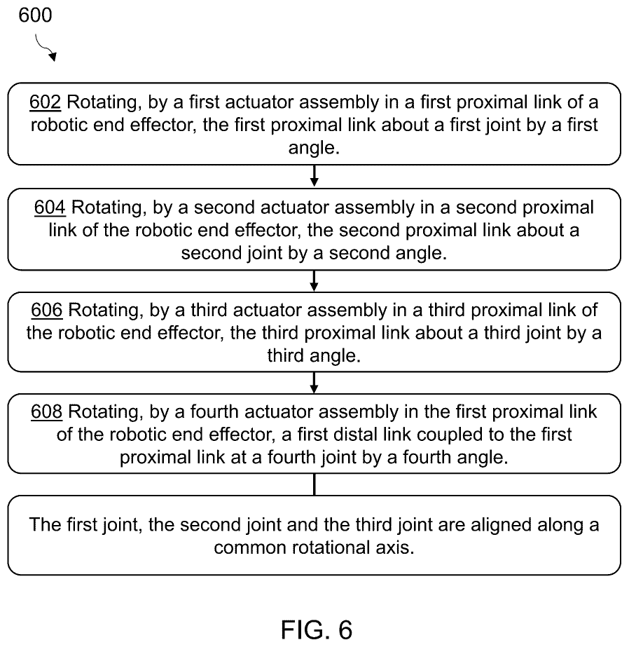

FIG. 6 is a flowchart of an exemplary computer-implemented method, according to an illustrative embodiment of the invention. At operation 602, a first actuator assembly in a first proximal link of a robotic end effector rotates the first proximal link about a first joint by a first angle. At operation 604, a second actuator assembly in a second proximal link of the robotic end effector rotates the second proximal link about a second joint by a second angle. At operation 606, a third actuator assembly in a third proximal link of the robotic end effector rotates the third proximal link about a third joint by a third angle. At operation 608, a fourth actuator assembly in the first proximal link of the robotic end effector rotates a first distal link about a fourth joint by a fourth angle. The first joint, the second joint, and the third joint are aligned along a common rotational axis.

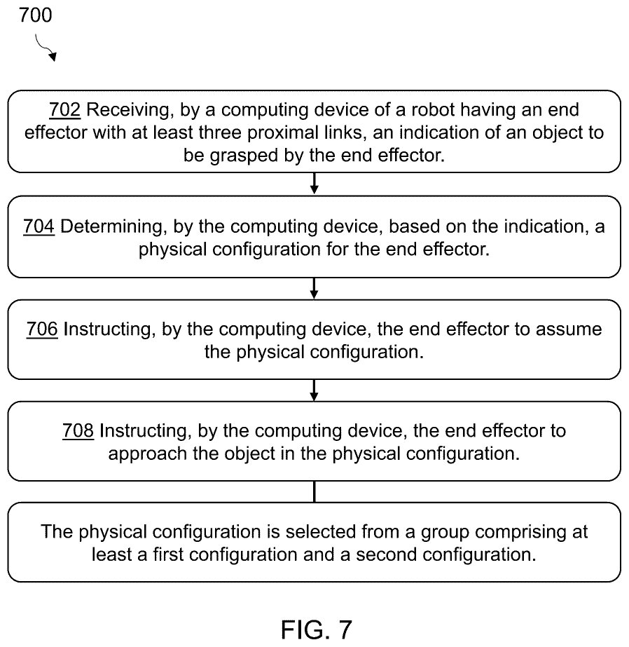

FIG. 7 is a flowchart of another exemplary computer-implemented method, according to an illustrative embodiment of the invention. In act 702, a computing device a robot having an end effector receives an indication of an object to be grasped by the end effector. In act 704, the computing device determines, based on the indication, a physical configuration for the end effector. In act 706, the computing device instructs the end effector to assume the physical configuration. In act 708, the computing device instructs the end effector to approach the object in the physical configuration.

A number of implementations have been described. Nevertheless, it will be understood that various modifications may be made without departing from the spirit and scope of the disclosure.

1. An apparatus for a robot comprising:
a set of at least three proximal links, each proximal link configured to rotate about a respective joint, each joint aligned on a common axis; and
a set of at least three distal links, each distal link coupled to a corresponding proximal link and configured to rotate about a second respective joint,
wherein each proximal link comprises an actuator configured to move at least one of the proximal link or the corresponding distal link.

2. The apparatus of claim 1, wherein each proximal link is configured to rotate independently of each other proximal link.

3. The apparatus of claim 1, wherein each distal link is configured to rotate independently of each other distal link and each proximal link.

4. The apparatus of claim 1, wherein each proximal link comprises a second actuator to move the other of the proximal link or the corresponding distal link.

5. The apparatus of claim 1, wherein each proximal link comprises a geared transmission.

6. The apparatus of claim 1, wherein each proximal link and each corresponding distal link form a modular finger member.

7. The apparatus of claim 1, wherein
each actuator comprises an electric motor having a clutched rotor,
each electric motor is mechanically coupled to a stepped spur gear, the electric motor having a rotary axis that is different from an axis of rotation of the corresponding proximal link, and
each stepped spur gear is mechanically coupled to a corresponding planetary gearbox.

8. The apparatus of claim 1, wherein
each proximal link is coupled to a common rigid member rotatable along an axis that is perpendicular to the common axis.

9. The apparatus of claim 1, wherein each proximal link has a linear dimension that is longer than a linear dimension of each corresponding distal link.

10. The apparatus of claim 1, wherein any two of the at least three proximal links are capable of rotation to an angular separation of at least 180 degrees.

11. The apparatus of claim 1, wherein any two of the at least three distal links are capable of rotation to an angular separation of at least 180 degrees when the two corresponding proximal links are aligned.

12. The apparatus of claim 1, wherein
at least one of the proximal links comprises a breakaway feature,
the breakaway feature comprises a deformable member configured to break when more than a first threshold force is applied along a first breakaway axis, and
the deformable member is further configured to break when more than a second threshold force is applied along a second breakaway axis, the first threshold force being different from the second threshold force, and the first breakaway axis being different from the second breakaway axis.

13. The apparatus of claim 1, wherein at least one of the proximal links comprises a slip clutch configured to slip when a threshold is met.

14. The apparatus of claim 1, further comprising a set of at least three additional links, each additional link coupled to a corresponding distal link and configured to rotate independently about a third respective joint.

15. The apparatus of claim 1, wherein at least one distal link comprises an exterior geometry that differs from at least one other distal link.

16. The apparatus of claim 1, wherein at least one distal link comprises a flat surface exterior, at least one distal link comprises a first tapered surface having a first pitch, and at least one distal link comprises a second tapered surface having a second pitch, the second pitch tapered away from the first pitch.

17. A method comprising:
rotating, by a first actuator assembly in a first proximal link of a robotic end effector, the first proximal link about a first joint by a first angle;
rotating, by a second actuator assembly in a second proximal link of the robotic end effector, the second proximal link about a second joint by a second angle;
rotating, by a third actuator assembly in a third proximal link of the robotic end effector, the third proximal link about a third joint by a third angle; and
rotating, by a fourth actuator assembly in the first proximal link of the robotic end effector, a first distal link coupled to the first proximal link at a fourth joint by a fourth angle,
wherein the first joint, the second joint and the third joint are aligned along a common rotational axis.

18. The method of claim 17, further comprising:
rotating a common rigid member coupled to each of the first, second and third proximal links,
wherein the common rigid member is rotatable along an axis that is perpendicular to the common rotational axis.

19. The method of claim 17, further comprising:
breaking a deformable member included in the first proximal link when more than a first threshold force is applied along a first breakaway axis; and.
breaking the deformable member when more than a second threshold force is applied along a second breakaway axis, the first threshold force being different from the second threshold force, and the first breakaway axis being different from the second breakaway axis.

20. An actuator assembly for a robot comprising:
an electric motor having a rotor configured to rotate about a rotary axis;
a first spur gear mechanically coupled to the rotor and configured to rotate about a first intermediate axis different from the rotary axis; and
a planetary gear mechanically coupled to the first spur gear, the planetary gear defining an axis of rotation of a robotic joint, wherein the axis of rotation of the robotic joint is displaced from the rotary axis of the rotor of the electric motor.
